(19) United States
(12) Patent Application Publication
(10) Pub. No.: US 2003/0207097 A1
(43) Pub. Date: Nov. 6, 2003

(54) Multilayer structure used especially as a material of high relative permittivity

(75) Inventor: Lionel Girardie, Eybens (FR)

Correspondence Address: HESLIN ROTHENBERG FARLEY & MESITI PC, 5 COLUMBIA CIRCLE, ALBANY, NY, 12203, US

(73) Assignee: MEMSCAP Le Parc Technologique des Fountaines, Bernin (FR)

(21) Appl. No.: 10/425,415

(22) Filed: Apr. 29, 2003

Related U.S. Application Data
(63) Continuation-in-part of application No. 10/328,881, filed on Dec. 24, 2002.

(30) Foreign Application Priority Data
Dec. 31, 2001 (FR) 01.17069
Feb. 11, 2002 (FR) 02.01618
Feb. 27, 2002 (FR) 02.02461
Mar. 20, 2002 (FR) 02.03442
Mar. 20, 2002 (FR) 02.03445
Mar. 20, 2002 (FR) 02.03444
Apr. 17, 2002 (FR) 02.04782
Apr. 30, 2002 (FR) 02.05465

(51) Int. Cl. B32B 9/00

(52) U.S. Cl. 428/216; 428/701; 428/702

(57) ABSTRACT

Multilayer structure, used especially as a material of high relative permittivity, characterized in that it comprises a plurality of separate layers, each having a thickness of less than 500 Å. Some of those layers are based on aluminium, hafnium and oxygen and especially based on hafnium dioxide (HfO₂) and on alumina (Al₂O₃). In practice, the hafnium dioxide and alumina layers form alloys of formula HfₓAl_{y}O_{z}. Advantageously, the stoichiometry of the HfₓAl_{y}O_{z} varies from one layer to another. Some of the layers containing HfₓAl_{y}O_{z} alloys, or some of the layers between those containing HfₓAl_{y}O_{z} alloys, also include a lanthanide element.

### CROSS REFERENCES TO RELATED APPLICATION

This application is a Continuation In Part of application serial number 10/328881 filed on Dec. 24, 2002, which in turn claims priority from the French patent applications 01.17069, filed on Dec. 31, 2001, 02.01618 filed on Feb. 11, 2002, 02.02461 filed on Feb. 27, 2002, 02.03442 filed on Mar. 20, 2002, 02.03445 filed on Mar. 20, 2002, 02.03444 filed on Mar. 20, 2002, 02.04782 filed on Apr. 17, 2002, and 02.05465 filed on Apr. 30, 2002, the entire disclosure of which are incorporated herein by reference.

### TECHNICAL FIELD

The invention relates to the field of microelectronics. It relates more specifically to a multilayer structure which can be used especially as a material of high relative permittivity. Such a material may be used to form the insulating layer of a capacitor. Such a capacitor may especially be used as a decoupling capacitor or as a filter capacitor integrated into radiofrequency circuits or the like.

This type of insulating material can also be used to be included in capacitive structures such as those forming the cells of embedded memories (embedded DRAMs). Such cells may be produced within an integrated circuit itself.

The invention also makes it possible to produce oxide gate multilayers (or gate stacks) that are found in transistors of a particular structure, also known by the name gate structure.

### PRIOR ART

In general, one of the generally desirable objectives for producing capacitive structures, whether they be capacitors or memory cells, is to increase the capacitance of the structure, that is to say the value of the capacitance per unit area, so as to minimize the size of the components.

This objective of seeking a higher capacitance is achieved especially by the use of dielectrics having as high a relative permittivity as possible.

The value of the capacitance also depends inversely on the distance separating the two electrodes of the structure. This is why it is generally sought to reduce the thickness of the layer of dielectric separating the two electrodes of a capacitive structure.

However, reducing this thickness poses certain physical problems that depend on the materials used. This is because when the dielectric layers are very thin, certain tunnel effect phenomena may arise that modify the behaviour of the capacitive structure, degrading the properties thereof.

Moreover, when a dielectric layer is subjected to too high a voltage, electrical breakdown phenomena may also arise. It is therefore possible to define, for each material, a maximum breakdown electric field above which it cannot be employed.

For example, certain materials are limited to voltages of the order of a few volts, whereas there is a need for capacitors, especially those used for decoupling operations, to be able to withstand voltages greater than 10 volts or so.

Furthermore, the level of leakage current is also a parameter that may be critical in some applications. Mention may especially be made of capacitors operating at high frequency, for which it is important for the behaviour of the capacitor to be maintained over the broadest possible frequency band. The level of leakage current is also critical for applications requiring a high degree of autonomy, when the capacitors are especially embedded in cordless appliances.

However, the level of leakage current depends especially on the crystalline structure of the dielectric.

Document FR 2 526 622 has proposed producing multilayer structures by combining titanium dioxide (TiO₂) and alumina (Al₂O₃) elementary layers so as to obtain materials having a relatively high permittivity.

This type of structure has the drawback that titanium dioxide (TiO₂) is a material having a low density and a permittivity that depends on the crystalline phase, which means that it has to be coupled with a material having an amorphous phase, including up to a temperature of 800° C., and having a high breakdown field. This is why, to avoid increasing the leakage current, that document proposes the superposition of TiO₂ and Al₂O₃ layers. The electrical performance characteristics of the material are used for TFT (thin film transistor) applications but are insufficient for capacitor cell decoupling applications. This is because, for some applications, the leakage currents are the determining factors for radiofrequency (RF) operation and especially for the generations of devices based on HBT-CMOS and HBT-BICMOS technology that are used in cordless communications appliances, and especially the future generations of mobile telephones known as UMTS. For the latter application, the standard on decoupling is such that it imposes leakage currents of less than 10⁻⁹ A/cm² at supply voltages of 5.5 V, by having a breakdown field of greater than 6 MV/cm. In order for such a dielectric to be able to be used in this application, it must possess a band gap energy of greater than 5.5 eV. However the TiO₂ and Al₂O₃ multilayer stack has only a band gap energy of 4 eV, a breakdown field of about 3.5 MV/cm and leakage currents close to 10⁻⁶ A/cm². It is very clearly apparent that the material described in that document, developed for TFT applications, cannot also be used for applications involving RF decoupling capacitors and capacitor cells incorporated into integrated circuits in HBT-CMOS and HBT-BICMOS technology.

It is one of the objectives of the invention to provide a material that can be used within various capacitive structures, which combines both a high relative permittivity value, with a high voltage withstand, and a low level of leakage current.

### SUMMARY OF THE INVENTION

The invention therefore relates to a multilayer structure that can be used especially as a material of high relative permittivity.

According to the invention, this structure is characterized in that it comprises a plurality of separate layers, each having a thickness of less than 500 Å, and some of which are based on aluminium, hafnium and oxygen. These layers may, for example, be based on hafnium dioxide (HfO₂) and on alumina (Al₂O₃). In practice, the layers composed of hafnium and alumina advantageously form alloys of formula HfₓAl_{y}O_{z}. Advantageously, the stoichiometry of the HfₓAl_{y}O_{z} alloys varies from one layer to another.

In other words, the material obtained according to the invention is in the form of an alternation of films having differing compositions and stoichiometries, for thicknesses of less than a few hundred angstroms, thus forming a nanolaminated structure. In practice, the thickness of the layers may preferably be less than 200 Å, or even less than 100 Å, or indeed less than 50 Å.

Surprisingly, it has been found that hafnium-oxygen-alumina alloys have properties which are similar to the most favourable properties of each of the components of the alloy.

Thus, hafnium dioxide is known to be a material of polycrystalline structure. This crystalline structure results in hafnium dioxide being the site of relatively high leakage currents, although this material is very insensitive to avalanche phenomena.

However, the leakage currents of hafnium dioxide are limited because of its atomic composition and its low oxygen vacancy density. Hafnium oxide is also resistant to interfacial impurity diffusion and intermixing, especially because of its high density, namely 9.68 g/cm². The mechanism for these leakage currents is based on tunnel effects.

Hafnium dioxide is also known for its somewhat high relative permittivity, of around 20, when this material is deposited by ALD (Atomic Layer Deposition) at a temperature below 350° C.

With regard to the voltage withstand, hafnium dioxide has a band gap energy of 5.68 eV for a breakdown field of 4 MV/cm.

As regards the uniformity of the relative permittivity, the current-voltage plot exhibits hysteresis corresponding to an SiO₂ equivalent thickness or EOT (Equivalent Oxide Thickness) of 1.8 nanometres for a 10 millivolt voltage range. This means that, for a slight variation in voltage applied to the material, the latter does not have exactly the same permittivity properties, which may introduce defects in the electrical behaviour of the capacitor, especially when it is subjected to voltage jumps.

As regards the other component of the alloy, namely alumina, this is known to possess an amorphous crystalline structure, favourable to low leakage currents, which follow the Poole-Frenkel mechanism. Alumina has a relative permittivity of 8.4, which value is less than that of hafnium dioxide.

On the other hand, alumina has a band gap energy of 8.7 eV and a breakdown field of 7 MV/cm, which values are greater than the values of the abovementioned hafnium dioxide.

Now, it has surprisingly been found that HfₓAl_{y}O_{z} alloys formed by these two materials have particularly beneficial properties especially as regards relative permittivity which is around 12 to 14. The voltage withstand is also advantageous, since the overall breakdown field is around 6 MV/cm.

Moreover, the alloys based on HfO₂ and Al₂O₃ make it possible to stop hafnium dioxide grain growth by the amorphous alumina phases. What is therefore obtained is a result that is characterized by a reduction in leakage currents, whereas a priori the two materials taken separately do not have a common mechanism as regards leakage currents.

The HfₓAl_{y}O_{z} alloys formed and deposited by ALD have advantages over a nanolaminated structure composed of a stack of successive HfO₂ and Al₂O₃ layers. These advantages are intimately connected with the structure of the grains of the alloy, with its density and with the enthalpy of formation, which give leakage currents of the order of 10⁻⁹ A/cm² at 5.5 V. Furthermore, the relative permittivity is higher than that of the stack of separate HfO₂ and Al₂O₃ layers. The electron transition (or barrier) energy with respect to a metal is greater than 3.4 eV. The band gap of the HfₓAl_{O}_{z} alloy is greater than 6.5 eV, while the nanolaminated structure composed of HfO₂ and Al₂O₃ layers has a band gap energy of 5.7 eV.

Moreover, the high cohesion of the crystals and the low oxygen vacancy density lead to good uniformity of the relative permittivity of the characteristic alloy when this is deposited by the ALD technique. The observed leakage currents are typically of the order of 1 nanoamp per cm² under a voltage of 5 volts. In practice, the deposition may be based on different ALD techniques, like for example, Single Wafer ALCVD (Atomic Layer Chemichal Vapour Deposition), or Single Wafer ALD, or Batch Furnace ALD, or Plasma Enhanced ALD.

In one particular embodiment, the multilayer structure of the invention may include external layers that are made only of alumina since, in this case, it is observed that alumina, Al₂O₃, has a high breakdown value and a relatively high band gap energy compared with the principal metals, especially tungsten, widely used to form electrodes of capacitive structures. The transition voltage threshold between alumina and tungsten is about 3.4 volts, which makes alumina particularly advantageous at the interface with metal, especially tungsten, electrodes.

It has also been found that the relative permitivitty can be increased if some of the layers include an oxide of a lanthanide (or rare earth) element. The rare earth element (RE) can be choosen among the entire family of the lanthanide elements, from Lanthanum to Ytterbium, and by extension to Lutetium and Yttrium. In practice, this oxide can be a natural oxide of lanthanide of formula RE₂O₃.

### ILLUSTRATIVE EXAMPLES

The various nanolaminated structures described below were produced using ALD techniques, by depositing the various components of the alloy simultaneously at a temperature of between 320 and 350° C.

By using this technique, it is possible to control the thickness of each of the layers and thus to guarantee good homogeneity of this layer over the entire surface of the elementary layer, and therefore to avoid sources of defects.

The ALD technique may use several sources of materials, namely solid, liquid or gaseous sources, which makes this technique very flexible and versatile. Moreover, it uses precursors which are the vectors of the chemical surface reaction and which transport material to be deposited. More specifically, this transport involves a process of chemisorption of the precursors on the surface to be covered, creating a chemical reaction with ligand exchange between the surface atoms and the precursor molecules.

The principle of this technique avoids the adsorption or condensation of the precursors, and therefore their decomposition. The nucleation sites are continually created until saturation of each phase of the reaction, between which a purge with an inert gas allows the process to be repeated. Deposition uniformity is ensured by the reaction mechanism and not by the reactants used, as is the case in CVD (Chemical Vapour Deposition) techniques since the thickness of the layers deposited by ALD depends on each precursor chemisorption cycle.

For this technique, it will be preferred to use, as precursors, chlorides and oxychlorides such as HfCl4 or TMA and ozone or H2O, metallocenes, metal acyls, beta-diketonates, or alkoxides.

Thus, in a first example of an operating method, the following steps are carried out in sequence: p1 injection of TMA (trimethylaluminium) at a temperature of 350° C. for a time T₁ that can vary depending on the desired amount of aluminium in the layer;

injection of an oxidizing agent, such as ozone, water or hydrogen peroxide, at a temperature between 250 and 350° C. for a time 1.5T₁;

injection of HfCl₄ at a temperature of 280° C. for a time T₂ that can vary depending on the desired amount of hafnium in the layer; and

injection of an oxidizing agent for a time 2T₂.

Consequently, a layer for formula AlₓO_{z1}Hf_{y}O_{z2} is produced and these operations can be repeated iteratively in order to obtain the desired nanolaminated structure.

In a second example of an operating method, the following steps are carried out in sequence:

injection of an alkoxyd as precursor that includes aluminium, at a temperature between 250° C. and 320° C.;

injection of a precursor that includes alkyl radicals and hafnium; and

injection of an oxidizing agent, such as ozone, water or hydrogen peroxide.

Consequently, a layer of formula AlₓO_{z1}Hf_{y}O_{z2} and these operations can be repeated iteratively in order to obtain the desired nanolaminated structure. The advantage of this example of an operating method lies in the fact that the injections are carried out all at the same temperature, close to 280° C. The phenomena of migration between elementary layers are therefore appreciably more restricted than in the case in which the temperature varies at each injection. The number of injections per elementary layer is also reduced so that the presence of impurities and the concentration of oxygen cross-diffusion and vacancies are reduced. The precursors may be TDEAH, based on the TDEA (tetrakis(diethylamino)) ligand for hafnium complexes, which is manufactured by certain companies such as Schumacher Inc.

Among the various examples produced, the following should be noted:

### Example A

| No. of the layer | Formula of the layer | Thickness of the layer |
|---|---|---|
| 1 | Al₂O₃ | 5 ångströms |
| 2 | Hf₂AlO_{5.5} | 15 ångströms |
| 3 | Hf₃Al₂O₉ | 20 ångströms |
| 4 | Hf₃AlO_{7.5} | 25 ångströms |
| 5 | Hf₅AlO_{11.5} | 25 ångströms |
| 6 | Hf₃Al₂O₉ | 15 ångströms |
| 7 | Al₂O₃ | 5 ångströms |

This nanolaminated structure has a relative permittivity of around 14.21, a breakdown field of 7.3 MV/cm, a band gap energy of 6.4 eV and an electron transition energy relative to tungsten nitride (WN) of 4.1 eV.

### Example B

| No. of the layer | Formula of the layer | Thickness of the layer |
|---|---|---|
| 1 | Al₂O₃ | 5 ångströms |
| 2 | Hf₂Al_{7.5} | 15 ångströms |
| 3 | HfAl₈O₁₄ | 20 ångströms |
| 4 | Hf₅AlO_{11.5} | 25 ångströms |
| 5 | HfAl₆O₁₁ | 15 ångströms |
| 6 | Hf₃Al₂O₉ | 15 ångströms |
| 7 | Al₂O₃ | 5 ångströms |

This nanolaminated structure has a relative permittivity of around 12.23 and a breakdown field of 6.8 MV/cm.

### Example C

| No. of the layer | Formula of the layer | Thickness of the layer |
|---|---|---|
| 1 | HfAl₈O₁₄ | 10 ångströms |
| 2 | Hf₃AlO_{7.5} | 20 ångströms |
| 3 | HfAl₆O₁₁ | 10 ångströms |
| 4 | Hf₅AlO_{11.5} | 25 ångströms |
| 5 | HfAl₆O₁₁ | 10 ångströms |
| 6 | Hf₃Al₂O₉ | 20 ångströms |
| 7 | HfAl₈O₁₄ | 10 ångströms |

This nanolaminated structure has a relative permittivity of around 12.91.

### Example D

| No. of the layer | Formula of the layer | Thickness of the layer |
|---|---|---|
| 1 | HfAl₉O₁₄ | 15 ångströms |
| 2 | Hf₃AlO_{7.5} | 20 ångströms |
| 3 | HfAl₆O₁₁ | 10 ångströms |
| 4 | Hf₅AlO_{11.5} | 25 ångströms |
| 5 | HfAl₆O_{11.5} | 10 ångströms |
| 6 | Hf₃Al₂O₉ | 15 ångströms |
| 7 | HfAl₈O₁₄ | 15 ångströms |

This nanolaminated structure has a relative permittivity of around 12.48.

### Example E

| No. of the layer | Formula of the layer | Thickness of the layer |
|---|---|---|
| 1 | HfAl₈O₁₄ | 10 ångströms |
| 2 | Hf₃AlO_{7.5} | 25 ångströms |
| 3 | Hf₂AlO_{5.5} | 13 ångströms |
| 4 | Hf₃AlO_{11.5} | 30 ångströms |
| 5 | Hf₃Al₂O₉ | 13 ångströms |
| 6 | Hf₅AlO_{11.5} | 30 ångströms |
| 7 | HfAl₆O₁₁ | 11 ångströms |

This nanolaminated structure has a relative permittivity of around 14.46, a breakdown field of 7 MV/cm, a band gap energy of 6.3 eV and an electron transition energy relative to tungsten nitride (WN) of 3.9 eV.

### Example F

| No. of the layer | Formula of the layer | Thickness of the layer |
|---|---|---|
| 1 | Hf₃Al₂O₉ | 10 ångströms |
| 2 | Pr₂O₃ | 25 ångströms |
| 3 | Hf₅Al₃O_{14.5} | 15 ångströms |
| 4 | Pr₂O₃ | 25 ångströms |
| 5 | Hf₅Al₃O_{14.5} | 15 ångströms |
| 6 | Pr₂O₃ | 25 ångströms |
| 7 | Hf₃Al₂O₉ | 10 ångströms |

This nanolaminated structure has a relative permittivity of around 21.5, and it can be used to obtain capacitive structure having a capacitance of around 7.6 nF/mm².

### Example G

| No. of the layer | Formula of the layer | Thickness of the layer |
|---|---|---|
| 1 | HfAl₈O₁₄ | 10 ångströms |
| 2 | Nd₂O₃ | 25 ångströms |
| 3 | HfAl₆O₁₁ | 15 ångströms |
| 4 | Nd₂O₃ | 25 ångströms |
| 5 | HfAl₆O₁₁ | 15 ångströms |
| 6 | Nd₂O₃ | 25 ångströms |
| 7 | HfAl₈O₁₄ | 10 ångströms |

This nanolaminated structure has a relative permittivity of around 16.32, and it can be used to obtain capacitive structure having a capacitance of around 5.7 nF/mm².

### Example H

| No. of the layer | Formula of the layer | Thickness of the layer |
|---|---|---|
| 1 | HfAl₄O₈ | 10 ångströms |
| 2 | Pr₂O₃ | 30 ångströms |
| 3 | Hf₅AlO_{11.5} | 20 ångströms |
| 4 | Pr₂O₃ | 30 ångströms |
| 5 | Hf₆Al₂O₁₅ | 20 ångströms |
| 6 | Pr₂O₃ | 30 ångströms |
| 7 | HfAl₄O₈ | 10 ångströms |

This nanolaminated structure has a relative permittivity of around 20.2, and it can be used to obtain capacitive structure having a capacitance of around 5.9 nF/mm².

### Example I

| No. of the layer | Formula of the layer | Thickness of the layer |
|---|---|---|
| 1 | Al₂O₃ | 5 ångströms |
| 2 | Hf₃Al₂O₉ | 15 ångströms |
| 3 | Yb₂O₃ | 25 ångströms |
| 4 | HfAl₄O₈ | 10 ångströms |
| 5 | Yb₂O₃ | 25 ångströms |
| 6 | Hf₃Al₂O₉ | 15 ångströms |
| 7 | Al₂O₃ | 5 ångströms |

This nanolaminated structure has a relative permittivity of around 18.95, and it can be used to obtain capacitive structure having a capacitance of around 8.37 nF/mm².

### Example J

| No. of the layer | Formula of the layer | Thickness of the layer |
|---|---|---|
| 1 | HfAl₄O₈ | 10 ångströms |
| 2 | Y₂O₃ | 25 ångströms |
| 3 | Hf₃Al₂O₉ | 20 ångströms |
| 4 | Y₂O₃ | 25 ångströms |
| 5 | HfAl₄O₈ | 10 ångströms |

This nanolaminated structure has a relative permittivity of around 14.1, and it can be used to obtain capacitive structure having a capacitance of around 6.91 nF/mm².

### Example K

| No. of the layer | Formula of the layer | Thickness of the layer |
|---|---|---|
| 1 | HfAl₆O₁₁ | 10 ångströms |
| 2 | Lu₂O₃ | 30 ångströms |
| 3 | Hf₅Al₃O_{14.5} | 20 ångströms |
| 4 | Lu₂O₃ | 30 ångströms |
| 5 | HfAl₆O₁₁ | 10 ångströms |

This nanolaminated structure has a relative permittivity of around 18.68, and it can be used to obtain capacitive structure having a capacitance of around 8.26 nF/mm².

### Example L

| No. of the layer | Formula of the layer | Thickness of the layer |
|---|---|---|
| 1 | HfAl₈O₁₄ | 8 ångströms |
| 2 | La₂HfAl₂O₈ | 25 ångströms |
| 3 | Hf₃Al₂O₉ | 12 ångströms |
| 4 | La₅Hf₅AlO_{21.5} | 30 ångströms |
| 5 | Hf₃Al₂O₉ | 12 ångströms |
| 6 | La₂HfAl₂O₈ | 25 ångströms |
| 7 | Al₂O₃ | 8 ångströms |

This nanolaminated structure has a relative permittivity of around 15.21, and it can be used to obtain capacitive structure having a capacitance of around 6.41 nF/mm².

### Example M

| No. of the layer | Formula of the layer | Thickness of the layer |
|---|---|---|
| 1 | Al₂O₃ | 4 ångströms |
| 2 | Hf₃Al₂O₉ | 10 ångströms |
| 3 | Ho₂O₃ | 26 ångströms |

This nanolaminated structure has a relative permittivity of around 19.95, and it can be used to obtain capacitive structure having a capacitance of around 22.04 nF/mm².

### Example N

| No. of the layer | Formula of the layer | Thickness of the layer |
|---|---|---|
| 1 | Al₂O₃ | 3.5 ångströms |
| 2 | Tb₂HfAl₂O₈ | 12.5 ångströms |
| 3 | Tb₂O₃ | 24 ångströms |

This nanolaminated structure has a relative permittivity of around 19.62, and it can be used to obtain capacitive structure having a capacitance of around 21.68 nF/mm².

Of course, the scope of the invention is not limited by the stoichometric values given for these various examples, rather the invention also covers many other variants provided that they respect the principle of the invention, namely a variation in the stoichiometry between the various components of the alloy from one layer to another.

1. A multilayer structure, especially used as a material of high relative permittivity, comprising a plurality of separate layers, each having a thickness of less than 500 Å, and some of said layers being based on aluminium, hafnium and oxygen, some of other layers being based on an oxide of a lanthanide element.

2. Multilayer structure according to claim 1, wherein some of the layers are based on hafnium dioxide (HfO₂) and on alumina (Al₂O₃).

3. Multilayer structure according to claim 1, wherein some of the layers are based on hafnium oxide (HfₓO_{z1}) and on aluminium oxide (Al_{y}O_{z2}).

4. Multilayer structure according to claim 1, wherein the layers based on hafnium oxide (HfₓO_{z1}) and on aluminium oxide (Al_{y}O_{z2}) are formed from alloys of formula HfₓAl_{y}O_{z}.

5. Multilayer structure according to claim 4, wherein the stoichiometries of the alloys of formula HfₓAl_{y}O_{z} vary from one layer to another.

6. Multilayer structure according to claim 1, wherein said oxide of a lanthanide element is a lanthanum oxide (La₂O₃), or Praseodymium oxide (Pr₂O₃), or Neodymium oxide (Nd₂O₃), or Yttrium oxide (Y₂O₃).

7. Multilayer structure according to claim 1, wherein the thickness of each layer is between 1 and 200 Å, preferably between 1 and 100 Å, and very preferably between 1 and 50 Å.

8. Multilayer structure according to claim 1, wherein said plurality comprises at least five layers.

9. Multilayer structure according to claim 1, wherein at least one of the external layer of the plurality of layers is made of alumina (Al₂O₃).

10. Multilayer structure according to claim 1, wherein each layer is deposited by the technique of “atomic layer deposition” (ALD).

11. A multilayer structure, especially used as a material of high relative permittivity, comprising a plurality of separate layers, each having a thickness of less than 500 Å, and some of said layers being based on a rare earth element, aluminium, hafnium and oxygen.

12. Multilayer structure according to claim 11, wherein some of the layers are based on rare earth dioxide (RE₂O₃), hafnium dioxide (HfO₂) and on alumina (Al₂O₃).

13. Multilayer structure according to claim 11, wherein some of the layers are based on rare earth oxide (RE_{w}O_{z3}), hafnium oxide (HfₓO_{z1}) and on aluminium oxide (Al_{y}O_{z2}).

14. Multilayer structure according to claim 11, wherein the layers based on on rare earth oxide (RE_{w}O_{z3}), hafnium oxide (HfₓO_{z1}) and on aluminium oxide (Al_{y}O_{z2}) are formed from alloys of formula RE_{w}HfₓAl_{y}O_{z}.

15. Multilayer structure according to claim 14, wherein the stoichiometries of the alloys of formula RE_{w}HfₓAl_{y}O_{z} vary from one layer to another.

16. Multilayer structure according to claim 11, wherein the thickness of each layer is between 1 and 200 Å, preferably between 1 and 100 Å, and very preferably between 1 and 50 Å.

17. Multilayer structure according to claim 11, wherein said plurality comprises at least five layers.

18. Multilayer structure according to claim 11, wherein at least one of the external layer of the plurality of layers is made of alumina (Al₂O₃).

19. Multilayer structure according to claim 11, wherein each layer is deposited by the technique of “atomic layer deposition” (ALD).
